(19) United States
(12) Patent Application Publication
(10) Pub. No.: US 2016/0337818 A1
(43) Pub. Date: Nov. 17, 2016

(54) USER EQUIPMENT SELECTION FOR MBSFN MEASUREMENTS

(71) Applicant: Nokia Technologies Oy, Espoo (FI)

(72) Inventors: Ilkka Antero KESKITALO, Oulu (FI); Jussi-Pekka KOSKINEN, Oulu (FI); Jarkko Tuomo KOSKELA, Oulu (FI); Lars DALSGAARD, Oulu (FI); Jorma Johannes KAIKKONEN, Oulu (FI)

(21) Appl. No.: 15/111,136

(22) PCT Filed: Jan. 31, 2014
(86) PCT No.: PCT/US2014/014267

§ 371 Date: Jul. 12, 2016

(51) Int. Cl. H04W 4/06; H04W 24/10

(52) U.S. Cl. CPC H04W 4/06; H04W 24/10

(57) ABSTRACT

Methods and apparatus, including computer program products, are provided for sending, by a user equipment, an indication of whether there is an intent to receive a multimedia broadcast multicast service; and receiving, by the user equipment in response to the sent indication, measurement configuration information for a multicast broadcast single-frequency network. Related apparatus, systems, methods, and articles are also described.

### FIELD

The subject matter disclosed herein relates to wireless communications.

### BACKGROUND

In the Third Generation Partnership Project (3GPP), Multimedia Broadcast Multicast Services (MBMS) relates to broadcast and multicast services provided via cellular. For example, a broadcast transmission may be provided over one or more cells to user equipment. Specifically, the cellular network may provide an application, such as mobile television, to a user equipment using for example a multicast broadcast single-frequency network (MBSFN) in which base stations transmit on the same frequency in a coordinated way to provide the mobile television broadcast.

### SUMMARY

Methods and apparatus, including computer program products, are provided for selecting user equipment to perform MBSFN measurements.

Methods and apparatus, including computer program products, are provided for sending, by a user equipment, an indication of whether there is an intent to receive a multimedia broadcast multicast service; and receiving, by the user equipment in response to the sent indication, measurement configuration information for a multicast broadcast single-frequency network.

In some example embodiments, one of more variations may be made as well as described in the detailed description below and/or as described in the following features. The indication may be signaled to a network in a radio resource control connected mode. The received measurement configuration information may represent a network selection of the user equipment to receive the measurement configuration information for the multicast broadcast single-frequency network. The user equipment may make, during an idle mode of the user equipment, one or more measurements of the multicast broadcast single-frequency network based on the received measurement configuration information. The measurement configuration information may be received, when the user equipment supports minimization of drive testing. The measurement configuration information may initiate at least one of a recording of the one or more measurements of the multicast broadcast single-frequency network or a reporting of the one or more measurements of the multicast broadcast single-frequency network. The recording may include recording one or more times when the one or more measurements are made and one or more locations where the one or more measurements are made. The indication being sent by the user equipment may be mandatory before the measurement configuration information is sent to the user equipment. The indication may be sent only when the user equipment allows the activation of the one or more measurements. The user equipment may be configured with an option to not perform the one or more measurements when the measurement configuration information is received. The measurement configuration information may initiate the reporting of the one or more measurements of the multicast broadcast single-frequency network. The user equipment may initiate the one or more measurements when the measurement configuration information is received. The indication may include at least one of an explicit indication and an implicit indication. The implicit indication may include a response to a received multimedia counting request. The implicit indication may include an interest indicator representing whether there is an interest in receiving the multimedia broadcast multicast service at the user equipment. The explicit indication may include a control message enabling measurements of the multicast broadcast single-frequency network.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts an example of a system, in accordance with some example embodiments;

FIG. 2 depicts an example of a process for user equipment selection for MBSFN measurements, in accordance with some example embodiments;

FIG. 3A depicts an example of a process at a user equipment, in accordance with some example embodiments;

FIG. 3B depicts an example of a process at a network node, in accordance with some example embodiments;

FIG. 4 depicts an example of a user equipment, in accordance with some example embodiments; and

FIG. 5 depicts an example of an access point, in accordance with some example embodiments.

Like labels are used to refer to same or similar items in the drawings.

### DETAILED DESCRIPTION

Multimedia Broadcast Multicast Services (MBMS) may include providing one or more measurement enhancements to enable services provided by MBMS via a Multimedia Broadcast Single-frequency network (MBSFN). For example, user equipment may perform MBSFN measurements and record for the measurements a corresponding geographic location of the user equipment to allow verification of actual MBSFN signal reception, planning and (re)configuration tasks for MBSFN areas, and/or selection of MBMS operational parameters. Moreover, the user equipment may be configured to perform and/or report the MBSFN measurements, such as reference signal received quality (RSRQ), reference signal received power (RSRP), block error rate (BLER), received signal strength indicator (RSSI), and the like, as part a Minimization of Drive Test (MDT) functionality.

MBSFN measurements may only be required to be performed by a user equipment when the user equipment is actively receiving MBMS service (for example, listening to a Physical Multicast Channel, PMCH). Moreover, not all user equipment may be capable of performing MBSFN measurements, so the MBSFN measurements may be limited to only MBMS-capable user equipment. However, not all MBMS-capable user equipment may be interested in decoding MBMS data, and, as such, may not or should not be required, or available, to perform MBSFN measurements.

In some example embodiments, the MDT functionality of a cellular network may be used to initiate selection of one or more user equipment to perform MBSFN measurements. This selection decision may be performed by the radio access network and/or core network.

In the case of the radio access network making the user equipment selection, a network management system may initiate a Trace job activation as part of the MDT activation. This Trace function may directly configure a radio access network, such as a base station or radio network controller (RNC), for the MBSFN measurements; the radio access network may then activate and configure at a user equipment the actual MBSFN measurement and reporting over a radio interface. Before activating and configuring the user equipment for MBSFN measurement and reporting, the radio access network may have information including user equipment capability information and/or information regarding whether the user equipment is actively receiving an MBMS service.

In the case of core network selection, the MDT measurement configuration and user equipment selection may be signaling-based MDT, in which the network management system selects the user equipment. The network management system may send an activation of a user equipment to a network node, such as a mobility management entity (MME). In response to the activation, the network node may signal MBSFN measurement activation via the radio access network to the user equipment, when the user equipment is in a radio resource control (RRC) connected mode (although the network node may need to wait for the user equipment to establish the RRC connection for this activation to occur). But MBMS reception may normally occur only when a user equipment is in an idle mode, so the network node (for example, the MME and the like) and the radio access network may not be aware of active MBMS reception. This may result in uncertain user equipment selection decisions for the network when initiating measurement and reporting (which may result in unnecessary signaling and inefficient operation).

In some example embodiments, the cellular network may determine whether a user equipment is capable of performing MBMS and MDT. For example, MBMS capability signaling may be used to signal user equipment capability with respect to MBMS and MDT. Moreover, the radio access network may, in some example embodiments, determine (for example, check) whether MBMS transmission is active. In some example embodiments, the radio access network and/or core network may use responses to for example, an MBMS counting request message (for example, MBMSCountingRequest message) to assess if there are any user equipment that can be activated for the MBSFN measurements. Alternatively or additionally, the radio access network or core network may, in some example embodiments, utilize an MBMS interest indication message (for example, MBMSInterestIndication message) to assess if there are any user equipment that can be activated for the MBSFN measurements.

In some example embodiments, network selection of one or more user equipment for MBSFN measurements may be based on one or more of the following: message responses from user equipment to an MBMS counting request; message responses from user equipment indicating whether MBSFN measurements may be performed; a specification release indicator from the user equipment (which may indicate whether MBSFN measurements may be mandatory); whether the user equipment has sent an MBMS interest indication (for example, an MBMSInterestIndication message); serving and/or neighboring cell measurements (for example, reference signal received power (RSRP), reference signal received quality (RSRQ), channel quality indicator (CQI), and the like); and/or a combination of these and other factors. One or more of the user equipment indications may be required/mandatory in order for the network to select a user equipment for MBSFN measurements. The user equipment indication may also include separate information regarding whether the user equipment allows the MBSFN measurement. For example, this separate indication may explicitly indicate to the network whether the user equipment may be selected for MBSFN measurements, whereas some of the other MBSFN related indications may be considered implicit indications to a network regarding whether a user equipment allows the MBSFN measurements.

When the network receives messages from a user equipment (for example, the counting request response message and/or MBMSInterestIndication message), and, the MBMS service is in active transmission (for example, MBMS subframes configured and scheduled in the multicast channel (MCCH)), the user equipment may be selected for MBSFN measurement and/or MBSFN measurement configuration information may be sent to the selected user equipment. However, a user equipment that has not sent a response to a counting request response message and/or sent an MBMS interest indication may not be selected and/or configured for MBSFN measurements and thus be allowed to ignore MBSFN measurements and configuration.

Before providing additional examples regarding the user equipment selection processes disclosed herein, the following provides a description of a system, in accordance with some example embodiments.

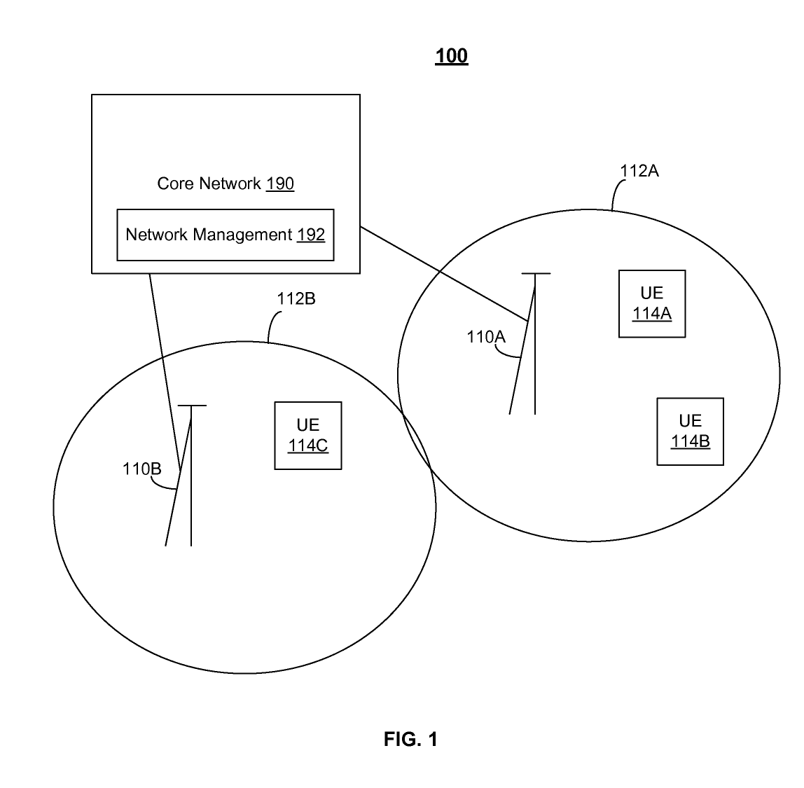

FIG. 1 depicts a system 100 including a core network 190, a plurality of base stations 110A-B serving cells 112A-B, where user equipment 114A-C are located, in accordance with some example embodiments. The core network 190 may include a network management system 192, which may further include a minimization of drive testing (MDT) function. The base stations may each provide a radio access network that serves a corresponding cell including user equipment. The base stations may also be configured as an evolved Node B (eNB) type base station, although other types of base stations and access points may be used as well. In the case of MBSFN, synchronized base stations may take part in an MBSFN transmission, and a user equipment may use a plurality of available MBSFN transmit signals from the base station in order to maximize reception quality.

Although FIG. 1 depicts a certain quantity and configuration of devices, other quantities and configurations may be implemented as well. For example, other quantities and configurations of base stations, cells, and user equipment may be implemented as well.

In some example embodiments, user equipment 114A-C may be implemented as a mobile device and/or a stationary device. The user equipment 114A-C are often referred to as, for example, mobile stations, mobile units, subscriber stations, wireless terminals, tablets, smart phones, wireless devices, devices, or the like. A user equipment may be implemented as, for example, a wireless handheld device, a wireless plug-in accessory, or the like.

In some example embodiments, user equipment 114A-C may be implemented as multi-mode user devices configured to operate using a plurality of radio access technologies, although a single-mode device may be used as well. For example, user equipment 114A-C may be configured to operate using a plurality of radio access technologies including one or more of the following: Long Term Evolution (LTE), wireless local area network (WLAN) technology, such as 802.11 WiFi and the like, Bluetooth, Bluetooth low energy (BT-LE), near field communications (NFC), and any other radio access technologies.

Base stations 110A-B may, in some example embodiments, be implemented as an evolved Node B (eNB) type base station as noted above, although other types of radio access points may be implemented as well. When the evolved Node B (eNB) type base station is used, the base station may be configured in accordance with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base station may also be configured to serve cells using a WLAN technology, such as WiFi (for example, the IEEE 802.11 series of standards), as well as any other radio access technology capable of serving a cell. Moreover, the base stations may be configured to provide synchronized transmission via a MBSFN transmission to one or more user equipment configured to received the MBSFN transmissions.

Base station 110 may have wired and/or wireless backhaul links to other networks and/or network nodes including core network 190. The core network 190 may include the network management entity 192, which may provide minimization of drive testing functions including the Trace function noted herein.

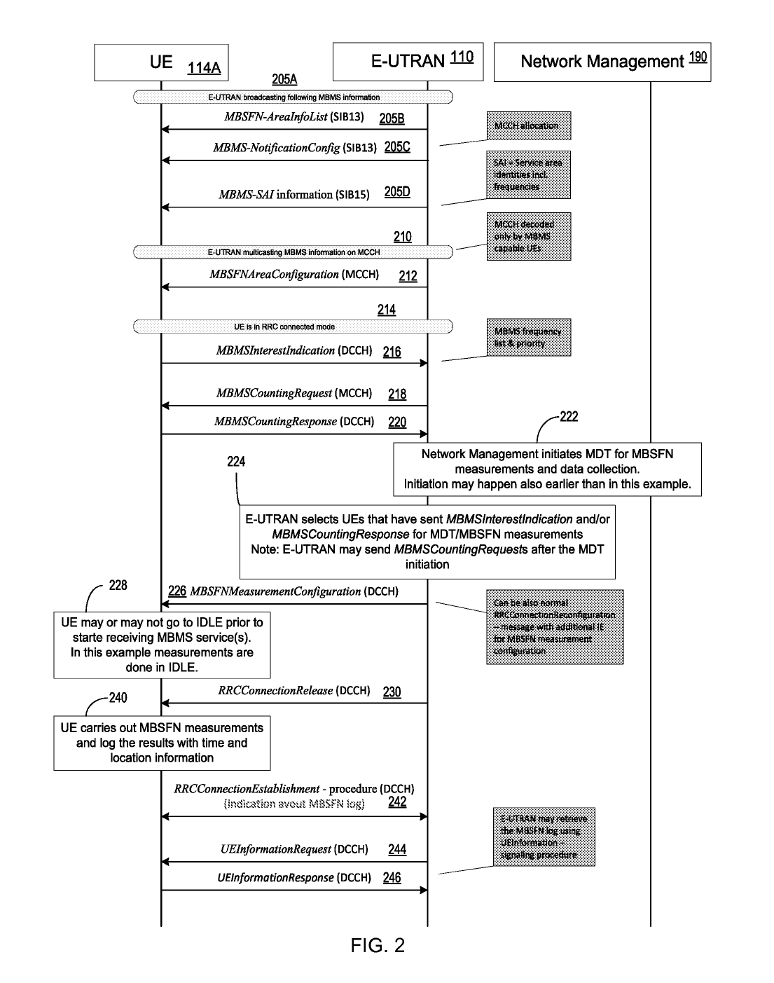

FIG. 2 depicts an example process 200 for user equipment selection for MBSFN measurements, in accordance with some example embodiments. The description of process 200 also refers to FIG. 1.

At 205A, the radio access network, such as base station 110A, may send to one or more user equipment MBMS information, in accordance with some example embodiments. The MBMS information may be broadcast to one or more user equipment 114A-B, and this MBMS information may include one or more of the following: MBSFN area information list (205B); MBMS notification configuration information (which may include a multicast channel (MCCH) allocation of time and/or frequency resources, 205C); and service area identity and frequency information (205D).

At 210, the radio access network, such as base station 110A, may multicast information on the MBMS control channel (MCCH), which may be decoded by those user equipment configured for MBMS. For example, the multicast information may, at 212, include MBSFN area configuration information, such as resource information and the like.

At 214, user equipment 114A may enter into an RRC connected mode. Next, the user equipment 114A may send, at 216, an MBMS interest indication via a dedicated control channel (DCCH), in accordance with some example embodiments. The radio access network/base station 110A may, at 218, send a counting request message at 218, via for example a multicast channel), in accordance with some example embodiments. The user equipment 114A may then respond via the DCCH to the counting request message with a counting request response at 220, in accordance with some example embodiments. The MBMS related information signaled from the user equipment may include, in accordance with some example embodiments, an explicit indication regarding whether the user equipment allows the MBSFN measurement. Additionally or alternatively, the MBMS signaling itself from the user equipment may be considered an implicit indication about allowing the MBMSFN measurements.

At 222, the network management system 192 may initiate MDT for MBSFN measurements and data collection based on at least the MBMS interest indication received at 216 and/or the MBMS counting response 220. For example, the network management system 192 may initiate a Trace function as part of MDT, which signals the radio access network to select a user equipment for MBSFN measurements. Although FIG. 2 depicts the MDT for MBSFN measurements and data collection initiated at a given time, the MDT for MBSFN measurements and data collection may be initiated at other times (including earlier) in process 200 as well.

At 224, a network node, such as base station 110A and/or any other node, may, in accordance with some example embodiments, select one or more user equipment that have sent an interest indication at 216 and/or responded to the counting request message at 220. In the example of FIG. 2, user equipment 114A may be selected due to interest indication 216 and/or counting response message 220.

At 226, a network node, such as base station 110A and/or any other node may send an MBSFN measurement configuration to user equipment 114A based on the selection at 224, in accordance with some example embodiments. For example, the MBSFN measurement configuration may indicate to the user equipment 114A to perform certain types of MBSFN measurements, record the measurements, record time, record a geolocation of when the measurement was made, and/or when and/or how to report the measurements to the network.

At 228, user equipment 114A may (or may not) go into an idle mode before starting MBMS services reception. At 230, the radio access network may send an RRC connection release message to user equipment 114A. In the example of FIG. 2, the MBSFN measurements are performed while in idle mode, although the measurements may be performed in other modes as well.

At 240, user equipment 114A (which has been selected to perform MBSFN measurements at 224) may perform one or more MBSFN measurements and record measured results with time and/or location information to enable subsequent reporting to the network. The measurements may include MBSFN RSRP and RSRQ per MBSFN area, MBSFN RSSI averaged over the orthogonal frequency division multiplex symbols carrying an MBSFN reference signal (RS), and/or multicast channel BLER per modulation code scheme per MBSFN area. Moreover, the MBSFN measurements may be performed only in subframes and carriers in which user equipment is decoding a physical multicast channel (PMCH).

At 242, user equipment 114A may initiate an RRC connection establishment procedure that may include an indication of the availability of the measurements recorded at 240. At 244, the radio access network may request the measurements recorded at 240, in which case user equipment 114A may respond with the measurements recorded at 240.

Process 200 may be used as noted with management-based MDT and signaling-based MDT. In the former, the radio access network may monitor MBMS activity and responses to counting requests. In the latter, the MBSFN measurement configuration for a user equipment may be dependent on a response to the counting request (or other MBMS related indications) from that particular user equipment. If no response to the counting request is received, the MBSFN measurement configuration may not be sent to the user equipment even though other factors/conditions may be satisfied. To illustrate further, a user equipment that has indicated interest in receiving MBMS may be configured for MBSFN measurements, but this configuration may take into account the user equipment's support of MDT (for example, based on the user equipment's MDT capability).

Although process 200 depicts the selection by the network at 244, the user equipment may itself initiate the MBSFN measurements when having indicated the interest in receiving the MBMS services. If no indications are sent, the measurements may not be started regardless of the MBMS reception.

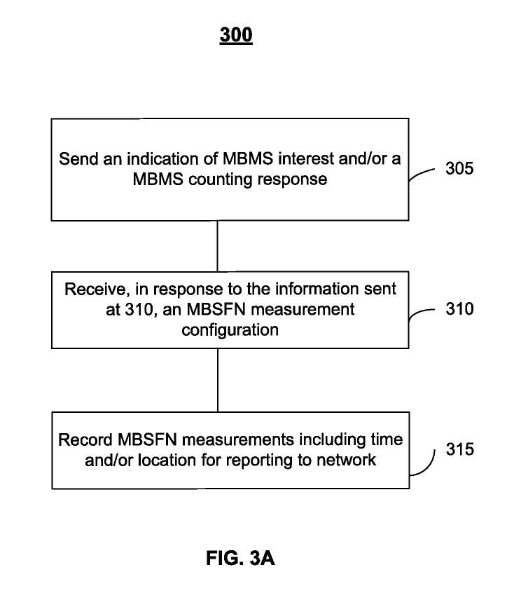

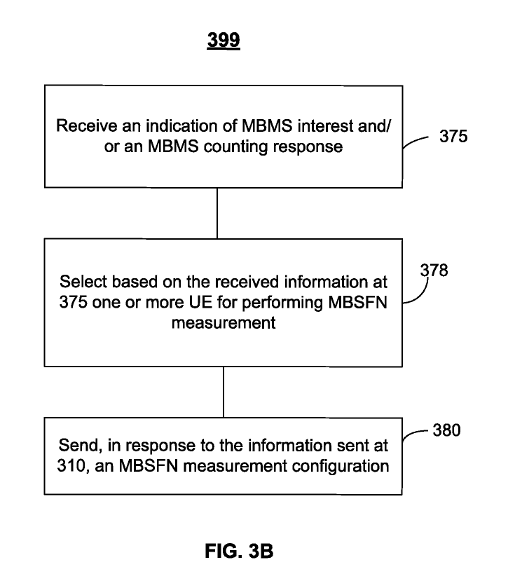

FIG. 3A depicts an example process 300 at user equipment 114A, in accordance with some example embodiments. The description of process 300 also refers to FIG. 1.

At 305, user equipment 114A may send to base station 110A an indication of MBMS interest and/or a response to an MBMS counting request, in accordance with some example embodiments. The indication and/or response may represent that user equipment 114A is capable and interested in MBMS services.

At 310, user equipment 114A may receive, in response to the information sent to the network at 305, an MBSFN measurement configuration, in accordance with some example embodiments. This measurement configuration may be similar to the configuration noted above with respect to 226.

At 315, the user equipment 114A may perform the configured MBSFN measurements, in accordance with some example embodiments. The measurements may be recorded along with for example a time of the measurement and/or a location of the measurement. The user equipment 114A may also signal the network, when connected, that MBSFN measurements are available for reporting.

FIG. 3B depicts an example process 399 at a network node, in accordance with some example embodiments. The description of process 399 also refers to FIG. 1.

At 375, a network node, such as base station 110A, may receive an indication of MBMS interest and/or a response to an MBMS counting request, in accordance with some example embodiments. The indication and/or response may be similar to 216 and/or 220 described above with respect to FIG. 2. At 378, a network node, such as base station 110A, may select one or more user equipment based on the information received at 375, in accordance with some example embodiments. At 380, a network node, such as base station 110A, may send an MBSFN measurement configuration, in accordance with some example embodiments. The MBSFN measurement configuration may be similar to 226 noted above with respect to FIG. 2.

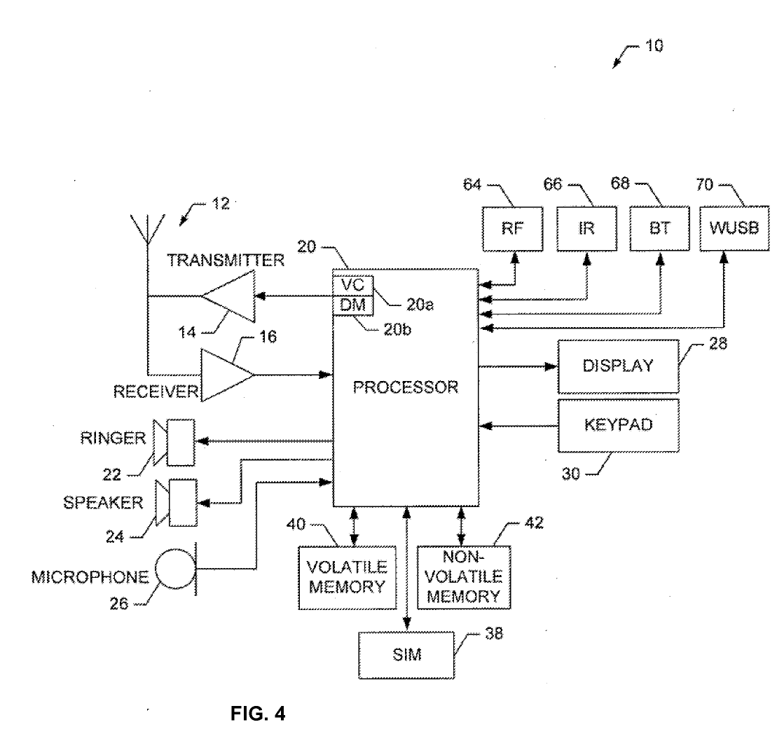

FIG. 4 illustrates a block diagram of an apparatus 10, in accordance with some example embodiments. For example, apparatus 10 may comprise a radio, such as a user equipment, a smart phone, mobile station, a mobile unit, a subscriber station, a wireless terminal, a tablet, a wireless plug-in accessory, a wireless access point, a base station, and/or or any other device with device having a transceiver.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth (BT) transceiver 68 operating using Bluetooth wireless technology, a wireless universal serial bus (USB) transceiver 70, a Bluetooth Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), a eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing user equipment processes at process 200, 300, and/or 399, and other operations associated with a user equipment. The memories may comprise an identifier, such as an international mobile equipment identification (IMEI) code, capable of uniquely identifying apparatus 10. The functions may include one or more of the operations disclosed herein with respect to the user equipment. The memories may comprise an identifier, such as an international mobile equipment identification (IMEI) code, capable of uniquely identifying apparatus 10. In the example embodiment, the processor 20 may be configured using computer code stored at memory 40 and/or 42 to provide User Equipment operations disclosed herein with respect to processes 200, 300, and/or 399.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 4, computer-readable medium may comprise a non-transitory computer-readable storage medium that may be any media that can contain or store the instructions for use by or in connection with an instruction execution system, apparatus, or device, such as a computer. For example, the computer-readable medium may include computer program code which when executed by processor circuitry may provide user equipment operations disclosed herein with respect to processes 200, 300, 399, and the like.

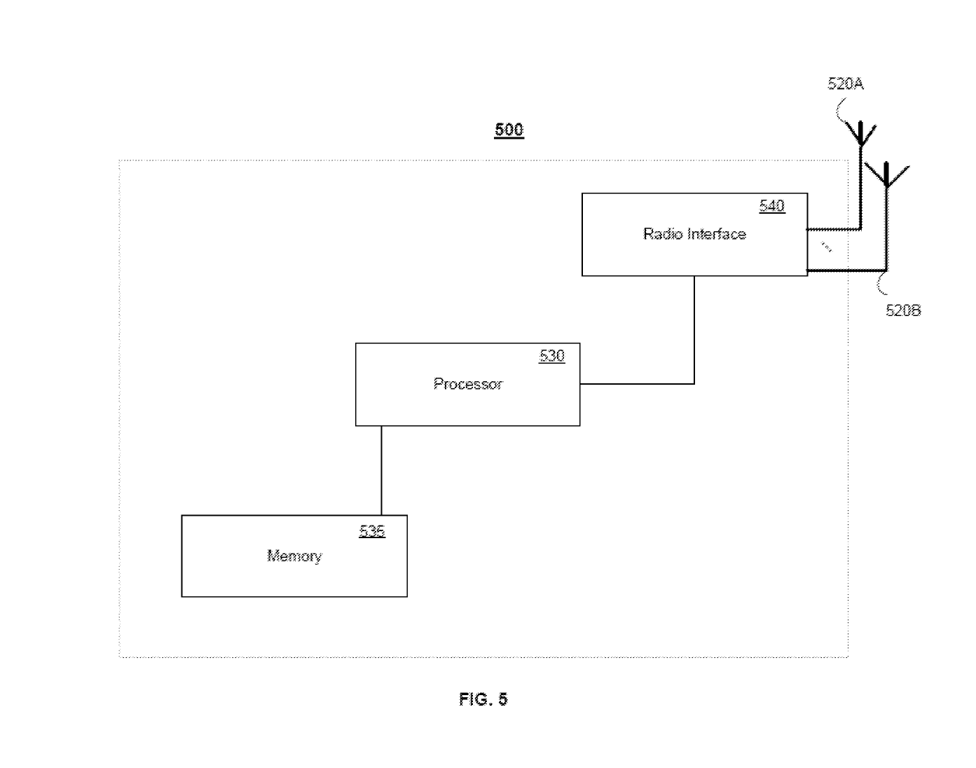

FIG. 5 depicts an example implementation of a wireless access point 500, which may be implemented at for example base stations 110A-C, in accordance with some example embodiments. The wireless access point may include one or more antennas 520 configured to transmit via downlinks and configured to receive uplinks via the antenna(s) 520. The wireless access access point may further include a plurality of radio interfaces 540 coupled to the antenna(s) 520. The radio interfaces 540 may correspond to a plurality of radio access technologies including one or more of LTE, WLAN, Bluetooth, Bluetooth low energy, NFC, radio frequency identifier (RFID), ultrawideband (UWB), ZigBee, ANT, and the like. The radio interface 540 may include components, such as filters, converters (for example, digital-to-analog converters and the like), mappers, a Fast Fourier Transform (FFT) module, and the like, to generate symbols for a transmission via one or more downlinks and to receive symbols (for example, via an uplink). The wireless access point may further include one or more processors, such as processor 530, for controlling the wireless access point 500 and for accessing and executing program code stored in memory 535. In some example embodiments, the memory 535 includes code, which when executed by at least one processor, causes one or more of the operations described herein with respect to the base station 110. For example, the wireless access point 500 may be configured to perform network node or base station processes in accordance with processes 200, 300, 399, and the like.

Without in any way limiting the scope, interpretation, or application of the claims appearing below, a technical effect of one or more of the example embodiments disclosed herein is more definite selection and configuration of user equipment for MBSFN measurements.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.” The use of the phase “such as” means “such as for example” unless otherwise indicated.

1-34. (canceled)

35. A method, comprising:
sending, by a user equipment, an indication of whether there is an intent to receive a multimedia broadcast multicast service; and
receiving, by the user equipment in response to the sent indication, measurement configuration information for a multicast broadcast single-frequency network.

36. The method of claim 35, wherein the indication is signaled to a network in a radio resource control connected mode.

37. The method of claim 35, wherein the received measurement configuration information represents a network selection of the user equipment to receive the measurement configuration information for the multicast broadcast single-frequency network.

38. The method of claim 35, further comprising:
making, during an idle mode of the user equipment, one or more measurements of the multicast broadcast single-frequency network based on the received measurement configuration information.

39. The method of claim 35, wherein the measurement configuration information is received, when the user equipment supports minimization of drive testing.

40. The method of claim 35, wherein the measurement configuration information initiates at least one of a recording of the one or more measurements of the multicast broadcast single-frequency network or a reporting of the one or more measurements of the multicast broadcast single-frequency network.

41. The method of claim 35, wherein the indication comprises at least one of an explicit indication and an implicit indication.

42. An apparatus comprising:
at least one processor; and
at least one memory including computer program code, the at least one memory and the computer program code configured to, with the at least one processor, cause the apparatus to perform at least the following:
send an indication of whether there is an intent to receive a multimedia broadcast multicast service; and
receive, in response to the sent indication, measurement configuration information for a multicast broadcast single-frequency network.

43. The apparatus of claim 42, wherein the indication is signaled to a network in a radio resource control connected mode.

44. The apparatus of claim 42, wherein the received measurement configuration information represents a network selection of the apparatus to receive the measurement configuration information for the multicast broadcast single-frequency network.

45. The apparatus of claim 42, wherein the apparatus is further caused to at least make, during an idle mode of the apparatus, one or more measurements of the multicast broadcast single-frequency network based on the received measurement configuration information.

46. The apparatus of claim 42, wherein the measurement configuration information is received, when the apparatus supports minimization of drive testing.

47. The apparatus of claim 42, wherein the measurement configuration information initiates at least one of a recording of the one or more measurements of the multicast broadcast single-frequency network or a reporting of the one or more measurements of the multicast broadcast single-frequency network.

48. The apparatus of claim 42, wherein the indication is sent only when the apparatus allows the activation of the one or more measurements.

49. The apparatus of claim 42, wherein the apparatus is configured with an option to not perform the one or more measurements when the measurement configuration information is received.

50. The apparatus of claim 42, wherein the indication comprises at least one of an explicit indication and an implicit indication.

51. The apparatus of claim 50, wherein the implicit indication comprises a response to a received multimedia counting request.

52. The apparatus of claim 50, wherein the implicit indication comprises an interest indicator representing whether there is an interest in receiving the multimedia broadcast multicast service at the user equipment.

53. The apparatus of claim 50, wherein the explicit indication comprises a control message enabling measurements of the multicast broadcast single-frequency network.

54. A non-transitory computer-readable medium encoded with instructions that, when executed by at least one processor, cause an apparatus to perform at least the following:
sending an indication of whether there is an intent to receive a multimedia broadcast multicast service; and
receiving, in response to the sent indication, measurement configuration information for a multicast broadcast single-frequency network.
